(19) United States
(12) Patent Application Publication
(10) Pub. No.: US 2011/0191171 A1
(43) Pub. Date: Aug. 4, 2011

(54) SEARCH ENGINE OUTPUT-ASSOCIATED BIDDING IN ONLINE ADVERTISING

(75) Inventor: Ali Dasdan, San Jose, CA (US)

(73) Assignee: Yahoo! Inc., Sunnyvale, CA (US)

(21) Appl. No.: 12/699,226

(22) Filed: Feb. 3, 2010

(51) Int. Cl. G06Q 30/00; G06F 17/30

(52) U.S. Cl. 705/14.49; 707/706; 707/E17.108

(57) ABSTRACT

Methods and systems are provided for search engine output-associated bidding in online advertising. Techniques are provided in which an advertiser may specify, as part of a bid, one or more requirements relating to search engine output. The one or more requirements may need to be met for an advertisement to be served in connection with the bid.

### BACKGROUND

In search advertising, or sponsored search, user-entered keyword queries provide an excellent signal for determining user intent and for targeting the user with an online advertisement. However, as with all forms of advertising, the best results are obtained only when all available sources of information are most effectively utilized.

There is need for more effective techniques for search advertising, including techniques for better utilizing available information, such as for targeting users and selecting advertisements.

### SUMMARY

Some embodiments of the invention provide methods and systems including utilizing search engine output in advertising. In some embodiments, in an auction-based format in which advertisers bid in connection with advertising, advertisers bids, and associated advertisements such as sponsored listings, may be associated with any form or forms of search engine output as well as input.

Herein, the term “search engine output” is intended to broadly include, for example, anything produced by a search engine or similar entity, such as any of various forms of data or metadata produced by a search engine, such as after processing any input query or other input. Search engine output can include, for example, organic results, sponsored results, facets, sites, URLs, etc. Search engine output can include search results, advertisements, site or query classifications, news, pictures, graphics, etc.

Some embodiments of the invention are described in connection with an advertiser bid being associated with a requirement (or requirements) associated with search engine output. Herein, the term requirement is intended to broadly include any of various associations or conditions associated with search engine output. For instance, a requirement can include a condition associated with search engine output. A requirement can include various associations such as keyword expansion in which keywords are derived from output, etc.

It is noted that, in some embodiments of the invention, output association can occur without matching any input query. For example, advertisements can be based at least in part on an input query, output, or both.

It is further noted that many types of situations and uses can be included in terms of one or more bid requirements associated with search engine output. For example, one such situation includes matching of an advertisement from a particular Web site with a result from the same site. In other situations, output can be used as a condition for matching advertisements. In yet another situation, output keywords, including keywords derived from output, can be used to expand input keywords for advertisement matching. In still other situations, bidding can be directly on output.

In some embodiments, content publishers and similar entities can be included. For example, in some embodiments, an advertisement may get associated with output that strongly corresponds to a particular content publisher, for example, by being associated with a Web site name. In some instances or circumstances, the publisher's permission or authorization may be required. In some embodiments, the content publisher may be rewarded for such permission, for example, by being made a party to share in revenue obtained from auctions associated with the particular output of the particular content publisher. For example, the reward may include a percentage of revenue or any other revenue sharing model. In some embodiments, such arrangements can help solve or mitigate monetary problems being experienced by news or information-provider Web sites, such as online encyclopedias, etc. For example, in some embodiments, a news or informational Web site can still profess to be “advertisement free”, but can still cause advertisements to be served that are associated with its site or pages of the site. For example, this could be facilitated by the news or informational Web site having pages that include keywords derived or chosen specifically for advertisement association.

Some embodiments of the invention provide methods and systems for search engine output-associated bidding in an online advertising auction. Techniques are provided in which an advertiser may specify, as part of, or in association with, a bid, one or more conditions relating to search engine output in relation to a keyword search query. The one or more conditions may need to be met for an advertisement to be served in connection with the bid. The one or more conditions may, for example, relate to inclusion or non-inclusion of an organic search result of a specified type, or to content of organic search results or associated Web pages or sites.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

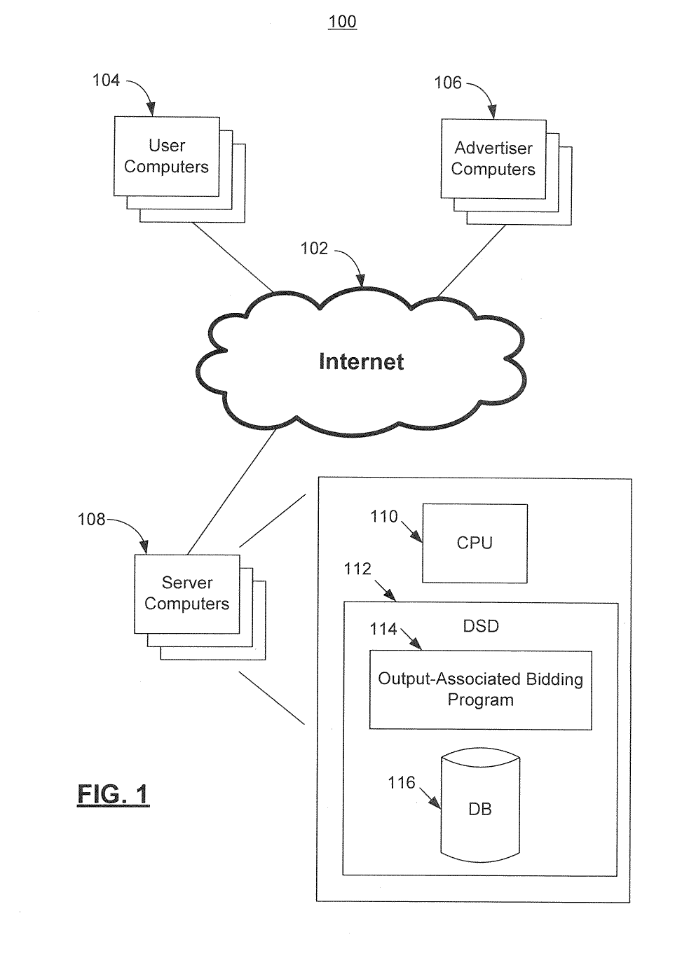

FIG. 1 is a distributed computer system 100 according to one embodiment of the invention. The system 100 includes user compute 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Output-Associated Bidding Program 114.

The Program 114 is intended to broadly include all programming, applications, algorithms, software and other and tools necessary to implement or facilitate methods and systems according to embodiments of the invention. The elements of the Program 114 may exist on a single server computer or may be distributed among multiple computers or devices.

Some embodiments of the invention provide methods and systems including utilizing search engine output in advertising. In some embodiments, in an auction-based format in which advertisers bid in connection with advertising, advertisers bids, and associated advertisements such as sponsored listings, may be associated with any form or forms of search engine output as well as input.

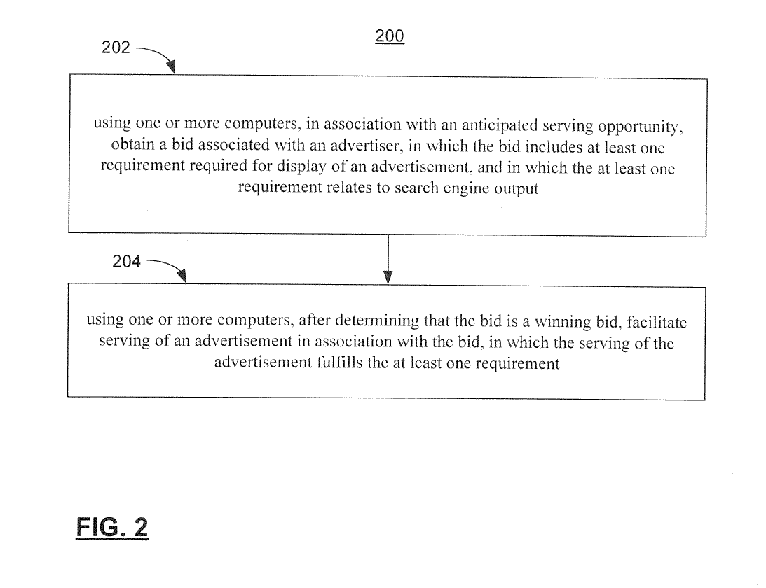

FIG. 2 is a flow diagram of a method 200 according to one embodiment of the invention. At step 202, using one or more computers, in association with an anticipated serving opportunity, a bid associated with an advertiser is obtained. Herein, the term “anticipated serving opportunity” includes anticipated equivalent serving opportunities, an anticipated serving opportunity of a specified profile or type, etc. The bid includes at least one requirement required for display of an advertisement. The at least one requirement relates to search engine output.

At step 204, using one or more computers, after determining that the bid is a winning bid, serving is facilitated of an advertisement in association with the bid. The serving of the advertisement fulfills the at least one requirement.

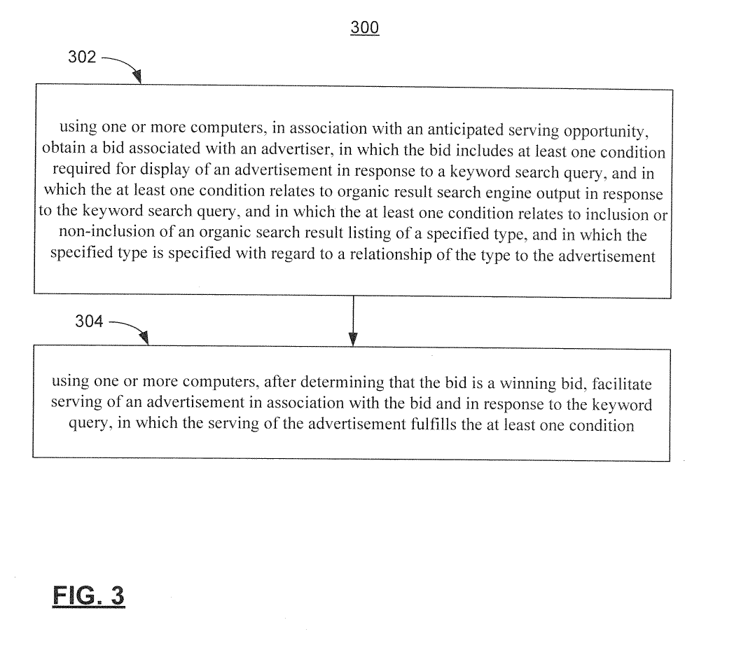

FIG. 3 is a flow diagram of a method 300 according to one embodiment of the invention. At step 302, using one or more computers, in association with an anticipated serving opportunity, a bid associated with an advertiser is obtained. The bid includes at least one condition required for display of an advertisement in response to a keyword search query. The at least one condition relates to organic result search engine output in response to the keyword search query. The at least one condition relates to inclusion or non-inclusion of an organic search result listing of a specified type. The specified type is specified with regard to a relationship of the type to the advertisement.

At step 304, using one or more computers, after determining that the bid is a winning bid, serving is facilitated of an advertisement in association with the bid and in response to the keyword query, in which the serving of the advertisement fulfills the at least one condition.

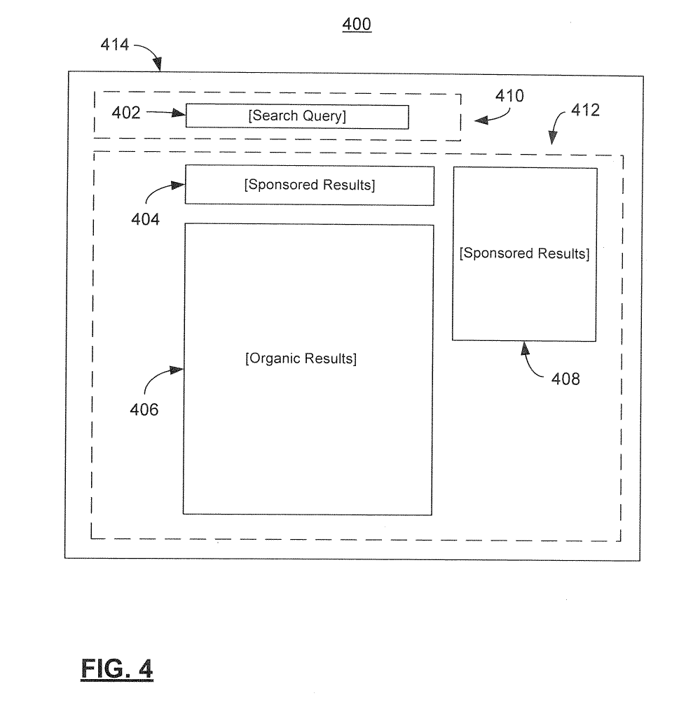

FIG. 4 is a block diagram 400 illustrating one embodiment of the invention. Specifically, an example screen shot 414 is depicted. The configuration of the screen shot 414 and its elements are merely used for illustrative purposes, and many different configurations are possible.

As depicted, the screen shot 414 includes search engine input 410 and search engine output 412. In different screen shot configurations, the search engine input 410 might not be included in the screen shot 414.

The search engine input 410 generally includes a keyword search query 402, such as a user-entered keyword search query.

The search engine output 412 includes elements including upper portion sponsored results 404, side portion sponsored results 408, and organic results 406 (sometimes known as algorithmic results).

The organic results 406, or organic result search engine output, may include a number of organic or algorithmic search result listings. Generally, the organic results are determined or selected by the search engine based at least in part on the search engine input 410, generally including the search query 402. Each of the listings may include a brief creative or descriptor, as well as a link to Web site or Web-based document or content associated with the listing. As search engine output has evolved, listings may also include other elements or complex or interactive content, such as local business listings, rich media elements, content sampled from linked Web pages, video content, audio content, etc.

Sponsored results 404, 408 are also included. Generally, the sponsored results 404, 408 include listings that are paid for by advertisers. The listings can include various elements, content, links, etc., including various elements similar to those included in organic results.

In some embodiments of the invention, advertisers bid for their advertisements or listings to be included in the sponsored results 404, 408. Winning bids may result in an advertisement being presented, and bidding may influence where in the display that an advertisement is presented. Other factors, such as various forms of targeting, etc., may also influence whether and where particular advertisements are presented. Search advertising, as known in the art, of course also includes numerous other aspects and complexities.

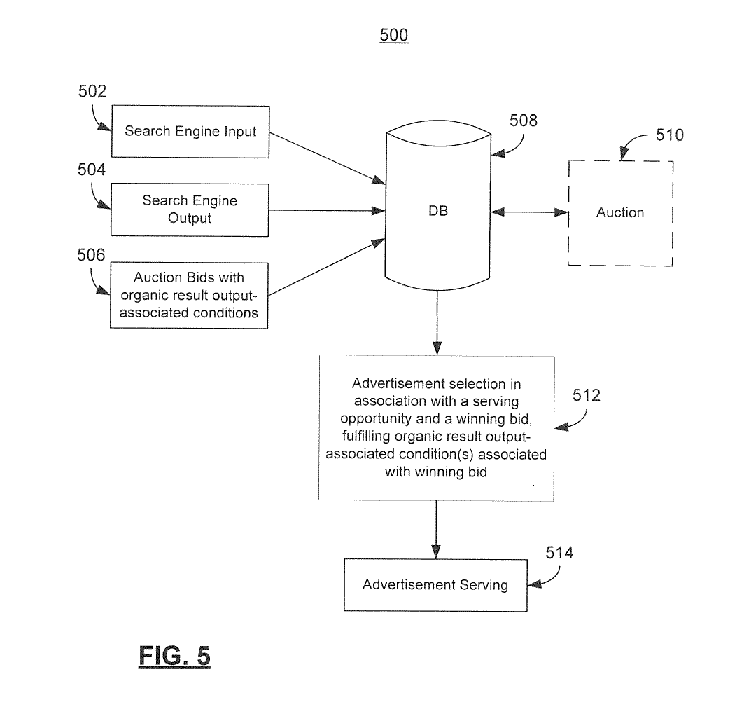

FIG. 5 is a block diagram 500 illustrating one embodiment of the invention. Block 502 represents search engine input, such as a user-entered or user-associated keyword search query.

Block 504 represents search engine output, such as organic result search engine output and sponsored result search engine output.

Block 510 represents a sponsored search bidding auction, which may be operated in connection with an exchange that may connect networks of parties including advertisers, publishers, and others.

Block 506 represents bids, received in connection with the auction. At least some of the bids include one or more conditions that must be met in order for advertisements to be displayed in connection with the bids. The one or more conditions relate to organic result search engine output.

As depicted, information associated with blocks 502, 504, 506 and 510 may be stored in one or more databases, such as database 508.

Information from the database 508 can then be used in sponsored result advertisement selection, represented generally by block 512, and serving and presentation, represented generally by block 514. Particularly, sponsored search advertisements may be selected, for display in association with a serving opportunity and based in part on a user-entered search query, and based in part on winning sponsored search advertiser bids including organic result search engine output-associated conditions. The selected advertisements, and their presentation, must fulfill organic result search engine output-related conditions associated with the pertinent winning bids.

Generally, sponsored results advertisement determination or selection is based at least in part on the user-entered search query, as well as advertiser bidding in connection with keyword terms and keyword term groups. Sponsored results may also be based in part on various forms of targeting, including user targeting techniques such as behavioral targeting, geo-targeting, etc.

Some embodiments of the present invention, however, are based in part on a recognition that search engine output, including organic results, constitutes a rich, valuable, and readily available source of information that can be used in sponsored results advertisement selection and presentation. Furthermore, some embodiments of the invention are based in part on a recognition that associations, including visual or presentation associations, can enhance the value and performance of listings including sponsored results advertisements. Still further, some embodiments of the invention include allowing sponsored result advertisers (including proxies of advertisers) to bid in connection with organic result search engine output. Particularly, some embodiments allow sponsored result advertisers to include, in their bids, conditions associated with organic result search engine output.

Some embodiments can be described with reference to the simplified equation:

Y=f(X) Eq. 1

In Eq. 1, Y represents search engine output, including organic results. f(X) represents a function relating to or representing the use, action, computation, or determinations of the search engine, based at least in part based on input X, where X represents a keyword search query.

Some embodiments of the invention include a recognition that, while X is important information, it is merely a few keywords. In many respects, Y, the search engine output including the organic results, is vastly greater in magnitude and richness, and represents the result of great effort and innovation via in connection with the search engine. Information included in organic results is readily available, highly valuable, and very diverse, and includes, for example: each of the organic listings themselves; one or more advertisers, companies, Web sites etc. associated with each listing; content and keywords associated with listings and creatives; links and URLs, included in listings, to Web pages, sites and other content; keywords and content associated with linked Web pages and resources; and other information. This diverse wealth of information can be utilized and leveraged to select high-performing sponsored advertisements and, in some embodiments, present sponsored advertisements in natural, effective, or synergistic association (or non-association) with particular organic listings. Furthermore, sponsored search auctions and auction structures, bidding and bidding structures, etc., can include requirements, conditions, or other factors relating to organic result search engine output. This can allow advertisers to leverage and apply their own information and understanding in order to maximize use of, and intelligence gained by, organic result output, including signaling relating to user intent.

In some embodiments, for example, an advertiser bid can specify a condition that a sponsored advertisement only appear when an associated organic listing appears. For example, a bid may specify that a Company A sponsored advertisement only appear if an organic listing for Company A is included in the organic results. In some embodiments, conditions may also be specified in relation to presentation of the sponsored advertisement. For example, a condition may require that the Company A sponsored advertisement be displayed next to, or otherwise in association with, the Company A organic listing. If potential for user confusion with respect to organic versus sponsored results is a concern, care can be taken, for example, to maintain a separation between the two, while still utilizing and leveraging visible or other associations.

Of course, many variations of conditions are possible. For example, Company A could specify a condition that a Company A sponsored advertisement only be shown if an organic listing is included of the same or a complementary business or information category or type as Company A, etc.

As another example, a company may specify a condition that a sponsored advertisement relating, for example, to accessories for an MP3 player, only be shown if an organic listing is also shown relating to an MP3 player.

As a further example, a sponsored search advertiser could include a condition relating to keywords included in organic results, or keywords included in Web sites or resourced linked to be organic listings, etc., or require that such keywords appear with a certain minimum frequency, etc. This type of bidding can be viewed as analogous in some ways to graphical advertising targeting techniques using matching relating to content of an associated Web page.

As still a further example, sponsored advertisers could specify various other conditions relating to display of listings. For example, an advertiser might specify that a sponsored advertisement for a particular company, such as a hardware store, only be shown if an organic result is included for a home supplies store, or a specific home supply store, etc. The sponsored advertiser could further specify that the sponsored advertisement must be shown in association with the hardware store organic listing, for example.

Still further, advertisers could specify negative conditions, such as that a particular sponsored advertisement not be shown if a certain organic listing, or type of organic listing, is included, or that a particular sponsored advertisement be shown only if a certain organic listing, or type of organic listing, is not included etc.

Of course, more complex conditionals, including conditionals that include Boolean operators, are possible and might also be utilized. Auction and auction structures can be designed or modified to accommodate such bidding.

While the invention is described with reference to the above drawings, the drawings are intended to be illustrative, and the invention contemplates other embodiments within the spirit of the invention.

1. A method for use in association with an online advertising auction, comprising:
using one or more computers, in association with an anticipated serving opportunity, obtaining a bid associated with an advertiser;
wherein the bid comprises at least one requirement required for display of an advertisement; and
wherein the at least one requirement relates to search engine output; and
using one or more computers, after determining that the bid is a winning bid, facilitating serving of an advertisement in association with the bid, wherein the serving of the advertisement fulfills the at least one requirement.

2. The method of claim 1, comprising storing the bid in at least one database.

3. The method of claim 1, comprising serving of the advertisement.

4. The method of claim 1, comprising serving of the advertisement to a targeted user.

5. The method of claim 1, wherein the at least one requirement specifies that an organic result listing relate in a specified way to the advertisement.

6. The method of claim 1, wherein the at least one requirement specifies that an organic result listing be similar in a specified way to the advertisement.

7. The method of claim 1, wherein the at least one requirement specifies that an organic result listing be of a topic associated with the advertisement.

8. The method of claim 1, wherein the at least one requirement specifies that an organic result listing be associated with a company with which the advertisement is also associated.

9. The method of claim 1, wherein the at least one requirement specifies that an organic result listing be associated with a Web site or Web page with which the advertisement is also associated.

10. The method of claim 1, wherein the at least one requirement relates to organic result content.

11. The method of claim 1, wherein the at least one requirement relates to content reachable from organic result content.

12. The method of claim 1, wherein the at least one requirement relates to content of Web pages associated with organic search result listings.

13. The method of claim 1, wherein the advertisement is displayed in association with an organic search result listing with which the advertisement is associated.

14. A system comprising:
one or more server computers coupled to a network; and
one or more databases coupled to the one or more servers;
wherein the one or more server computers are for:
in association with an anticipated serving opportunity, obtaining a bid associated with an advertiser;
wherein the bid comprises at least one requirement required for display of an advertisement; and
wherein the at least one requirement relates to search engine output; and
after determining that the bid is a winning bid, facilitating serving of an advertisement in association with the bid, wherein the serving of the advertisement fulfills the at least one requirement.

15. The system of claim 14, wherein the one or more server computers are coupled to the Internet.

16. The system of claim 14, comprising storing the bid in at least one of the one or more databases.

17. The system of claim 14, comprising serving the advertisement.

18. The system of claim 14, wherein the at least one requirement relates to inclusion or non-inclusion of an organic search result listing of a specified type, and wherein the specified type is specified with regard to a relationship of the type to the advertisement.

19. The system of claim 14, wherein the bid is in connection with an online advertising auction that is associated with an online advertising exchange.

20. A computer readable medium or media containing instructions for executing a method for use in association with an online advertising auction, the method comprising:
using one or more computers, in association with an anticipated serving opportunity, obtaining a bid associated with an advertiser;
wherein the bid comprises at least one requirement required for display of an advertisement; and
wherein the at least one requirement relates to search engine output; and
using one or more computers, after determining that the bid is a winning bid, facilitating serving of an advertisement in association with the bid, wherein the serving of the advertisement fulfills the at least one requirement.
